(19) United States
(12) Patent Application Publication
(10) Pub. No.: US 2017/0116777 A1
(43) Pub. Date: Apr. 27, 2017

(54) IMAGE PROCESSING METHOD AND APPARATUS

(71) Applicant: Samsung Electronics Co., Ltd., Suwon-si (KR)

(72) Inventors: YOUNG JU JEONG, Yongin-si (KR); Yang Ho CHO, Seongnam-si (KR); Hyun Sung CHANG, Seoul (KR); Dong Kyung NAM, Yongin-si (KR)

(73) Assignee: Samsung Electronics Co., Ltd., Suwon-si (KR)

(21) Appl. No.: 15/156,607

(22) Filed: May 17, 2016

(30) Foreign Application Priority Data
Oct. 21, 2015 (KR) 10-2015-0146783

(51) Int. Cl. G06T 15/20; G06T 15/04; G06T 15/50; G06T 15/06

(52) U.S. Cl. CPC G06T 15/205; G06T 15/06; G06T 15/04; G06T 15/503; G06T 15/506

(57) ABSTRACT

An image processing apparatus may estimate a hole region based on a two-dimensional (2D) color image and a depth image corresponding to the 2D color image, and estimate color information and depth information of the hole region. The image processing apparatus may determine a view direction of an image pixel corresponding to the hole region based on the depth information of the hole region, and allocate a color value of the image pixel to a location of a display pixel corresponding to the determined view direction.

### CROSS-REFERENCE TO RELATED APPLICATION

This application claims under 35 U.S.C. §119 to Korean Patent Application No. 10-2015-0146783, filed on Oct. 21, 2015, in the Korean Intellectual Property Office, the entire contents of which are incorporated herein by reference in its entirety.

### BACKGROUND

1. Field

At least one example embodiment relates to image processing technology for rendering a three-dimensional (3D) image.

2. Description of the Related Art

A type of displaying a three-dimensional (3D) image by a 3D display device may include a glass type requiring 3D glasses to allow a user to view a 3D image and a glassless type reproducing a 3D image without a need for 3D glasses. In the glassless type, a light field method may reproduce, through a display, light rays output in various directions from points present in a space. In general, such a light field reproducing method may include generating N intermediate images based on at least two input images to generate multiview images to be displayed, and determining 3D image information to be output from each pixel of a 3D display device based on the generated N intermediate images. Here, when the intermediate images are generated, the generated intermediate images may include a region lacking in such information. The region lacking in the information may correspond to a background region in an input image that is occluded by a foreground region in the input image. To provide a natural 3D image to a user, restoring such a region lacking in information may be desired.

### SUMMARY

At least one example embodiment relates to an image processing method.

In at least one example embodiment, the method may include estimating a hole region based on a two-dimensional (2D) color image and a depth image corresponding to the 2D color image, estimating color information and depth information of the hole region, determining a view direction of an image pixel corresponding to the hole region based on the depth information of the hole region, and allocating a color value of the image pixel to a location of a display pixel corresponding to the view direction.

The allocating may include determining the location of the display pixel using a first model associated with a view direction of the display pixel and a second model associated with the view direction of the image pixel.

The method may further include determining a view direction of an image pixel of the 2D color image based on the depth image corresponding to the 2D color image, and allocating a color value of the image pixel of the 2D color image to a location of a display pixel corresponding to the view direction of the image pixel of the 2D color image.

The method may further include generating a three-dimensional (3D) image based on a result of the allocating of the color value of the image pixel corresponding to the hole region and a result of the allocating of the color value of the image pixel of the 2D color image.

The method may further include detecting a boundary region between a foreground and a background in the 2D color image, determining a blended color value by blending a color of the foreground and a color of the background in the boundary region, and allocating the blended color value to a location of a display pixel corresponding to the boundary region.

The method may further include determining whether the location of the display pixel to which the color value of at least one of the image pixel corresponding to the hole region and the image pixel of the 2D color image is allocated is included in a smoothing region, and allocating the color value of the image pixel or a smoothed color value obtained by performing smoothing to the location of the display pixel based on a result of the determining.

At least one example embodiment relates to an image processing apparatus.

In at least one example embodiment, the apparatus may include at least one processor, and at least one memory configured to store instructions to be implemented by the processor. When being implemented by the processor, the instructions may allow the processor to estimate a hole region based on a 2D color image and a depth image corresponding to the 2D color image, estimate color information and depth information of the hole region, determine a view direction of an image pixel corresponding to the hole region based on the depth information of the hole region, and allocate a color value of the image pixel to a location of a display pixel corresponding to the determined view direction.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of example embodiments, taken in conjunction with the accompanying drawings of which:

FIGS. 1 and 2 are flowcharts illustrating an image processing method according to at least one example embodiment;

FIG. 3 is a diagram illustrating a process of generating a three-dimensional (3D) image according to at least one example embodiment;

FIG. 4 is a diagram illustrating a process of generating a hole map according to at least one example embodiment;

FIGS. 5 through 9 are diagrams illustrating a process of generating a 3D image according to at least another example embodiment;

FIG. 10 is a flowchart illustrating a process of performing light field-based image post-processing according to at least one example embodiment;

FIGS. 11 and 12 are a flowchart and a diagram illustrating a process of performing light field-based image post-processing according to at least another example embodiment;

FIG. 13 is a flowchart illustrating an image processing method according to at least another example embodiment;

FIG. 14 is a flowchart illustrating an image processing method according to at least still another example embodiment; and

FIG. 15 is a diagram illustrating an image processing apparatus according to at least one example embodiment.

### DETAILED DESCRIPTION

Inventive concepts will now be described more fully with reference to the accompanying drawings, in which example embodiments of are shown. These example embodiments are provided so that this disclosure will be thorough and complete, and will fully convey inventive concepts of to those skilled in the art. Inventive concepts may be embodied in many different forms with a variety of modifications, and a few embodiments will be illustrated in drawings and explained in detail. However, this should not be construed as being limited to example embodiments set forth herein, and rather, it should be understood that changes may be made in these example embodiments without departing from the principles and spirit of inventive concepts, the scope of which are defined in the claims and their equivalents. Like numbers refer to like elements throughout. In the drawings, the thicknesses of layers and regions are exaggerated for clarity.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Specific details are provided in the following description to provide a thorough understanding of example embodiments. However, it will be understood by one of ordinary skill in the art that example embodiments may be practiced without these specific details. For example, systems may be shown in block diagrams so as not to obscure example embodiments in unnecessary detail. In other instances, well-known processes, structures and techniques may be shown without unnecessary detail in order to avoid obscuring example embodiments.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “includes”, “including”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Expressions such as “at least one of,” when preceding a list of elements, modify the entire list of elements and do not modify the individual elements of the list.

In rendering a three-dimensional (3D) image having a 3D effect based on an input image, processing a hole region may be desired. Although the hole region lacks related image information because the hole region is not viewed in the input image, the hole region may be expressed in an output image. Example embodiments to be described hereinafter may be applicable to estimating and restoring a hole region from an input image and rendering a 3D image. Further, example embodiments may be applicable to performing light field-based image post-processing on a generated 3D image. Example embodiments may be provided as various forms of products, for example, a 3D television (TV), a 3D monitor, a 3D smartphone, a 3D tablet, a 3D digital information display (DID), and a head mounted display (HMD).

As used herein, terms such as “depth” and “disparity” may be interchangeably used. In addition, an operation of converting a depth to a disparity or vice versa may be added to example embodiments. Such a conversion may be readily performed through a well-known related method, and thus a detailed description of the method will be omitted here.

Hereinafter, example embodiments will be described in detail with reference to the accompanying drawings. Like numbers refer to like elements throughout the description of the figures.

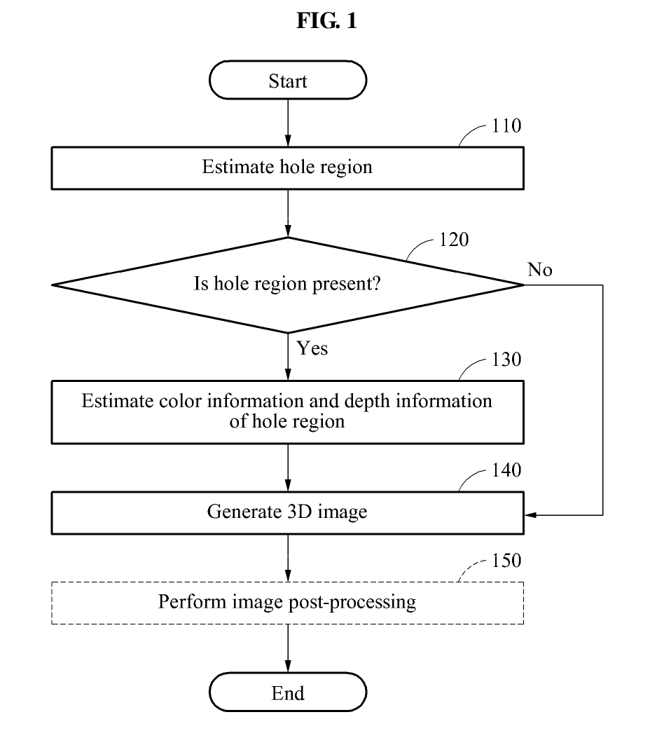

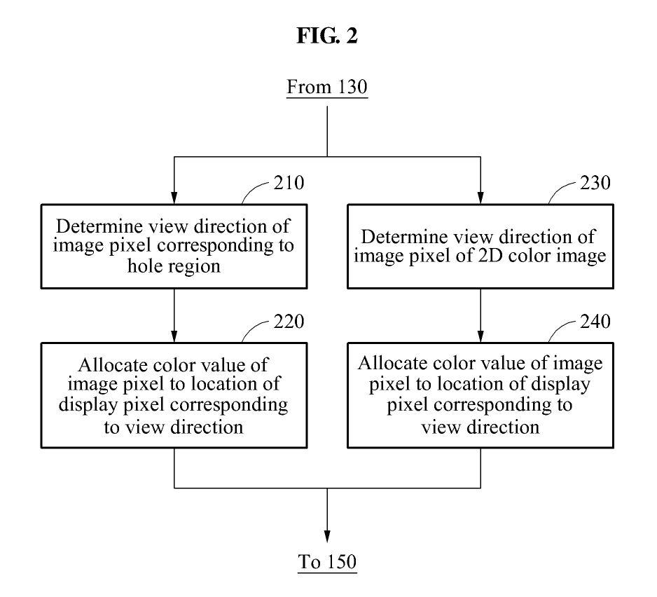

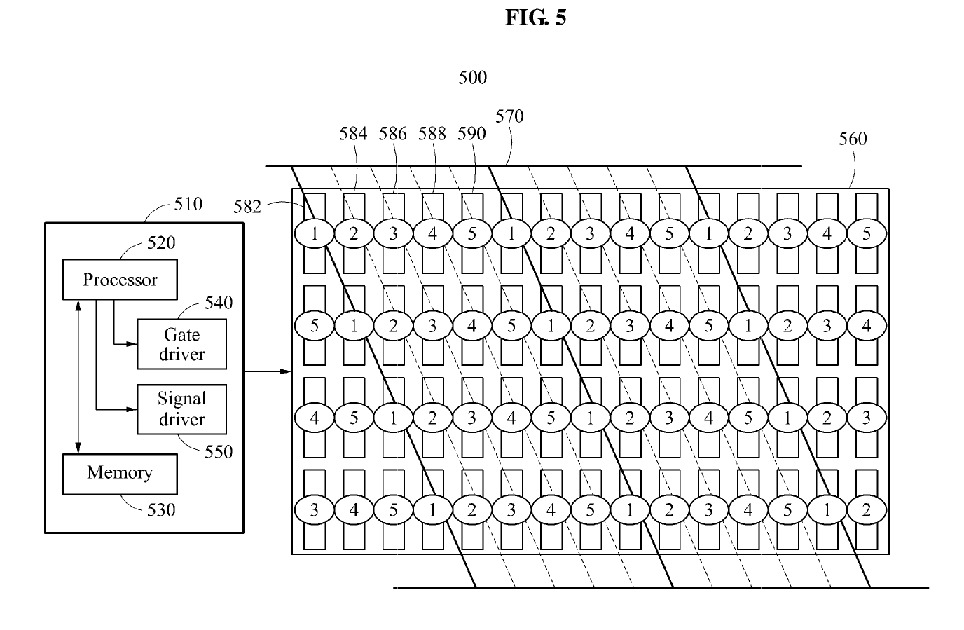

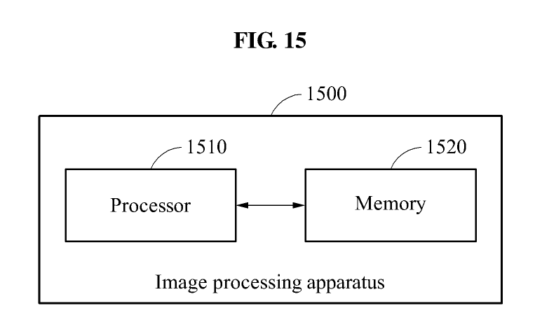

FIGS. 1 and 2 are flowcharts illustrating an image processing method according to at least one example embodiment. The image processing method may be performed by an image processing apparatus, for example, an image processing apparatus 510 illustrated in FIG. 5 or an image processing apparatus 1500 illustrated in FIG. 15. The image processing apparatus may receive, as an input image, a two-dimensional (2D) color image and a depth image corresponding to the 2D color image, and generate a 3D image based on the 2D color image and the depth image. For example, the 2D color image may be a view image, a stereo image, or a multiview image. The depth image may include depth information indicating a distance from an image capturing location to an object. According to at least one example embodiment, the depth image corresponding to the 2D color image is not input. In such a case, the image processing apparatus may generate the depth image by estimating the depth information from the 2D color image.

The image processing apparatus may render the 3D image by reproducing a light distribution, or a light field, corresponding to the 3D image to be displayed. For example, the image processing apparatus may configure the 3D image by reproducing, on a display plane, a light distribution based on each location and direction. Here, the image processing apparatus may estimate and restore a hole region based on the input image, and apply color information associated with the restored hole region to the 3D image. Further, the image processing apparatus may perform image post-processing to improve a quality of the 3D image. Hereinafter, the image processing method will be described in more detail with reference to FIG. 1.

Referring to FIG. 1, in operation 110, the image processing apparatus estimates a hole region based on a 2D color image, a depth image, and a stereoscopic parameter. As a result of the estimating, the hole region may not occur. The stereoscopic parameter refers to a parameter for adjusting a 3D effect of a 3D image, and relates to a distance difference between a foreground and a background expressed in the 3D image at a viewing location. A size of the hole region may vary depending on the stereoscopic parameter, and the stereoscopic parameter may be selected by a user and/or a design parameter based on empirical evidence.

The image processing apparatus may calculate a disparity difference of each image pixel included in the 2D color image, for example, a left difference ΔdL and a right difference ΔdR, based on the 2D color image and the depth image, and estimate one of or both of a hole region in a horizontal direction and a hole region in a vertical direction based on the disparity difference and the stereoscopic parameter. The hole region in the horizontal direction refers to a hole region occurring when the foreground moves in the horizontal direction, and the hole region in the vertical direction refers to a hole region occurring when the foreground moves in the vertical direction. A disparity of an image pixel included in the 2D color image may be determined based on a depth value at a corresponding location in the depth image. The image processing apparatus may determine, to be the hole region, a region occluded by the foreground using the disparity difference. The image processing apparatus may form a hole map including the hole region and a non-hole region based on the region determined to be the hole region.

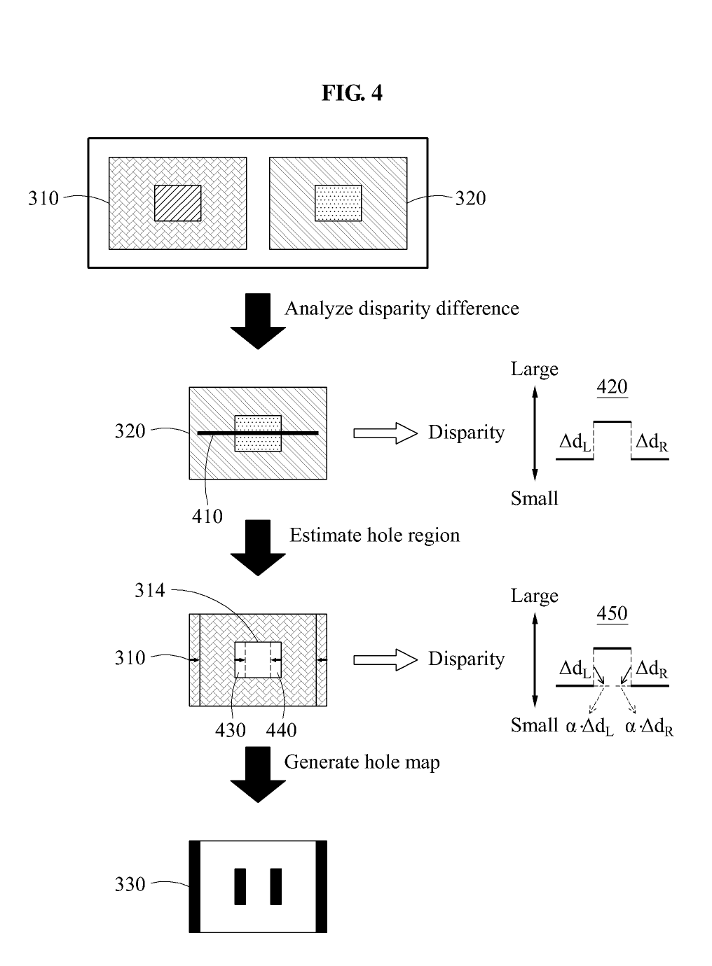

A process of forming a hole map by estimating a hole region, as performed by the image processing apparatus, will be described in more detail with reference to FIG. 4.

In operation 120, the image processing apparatus determines whether the hole region is present. In operation 130, in response to a determination of the presence of the hole region, the image processing apparatus restores the hole region by estimating color information and depth information of the hole region. For example, the image processing apparatus may estimate the color information and the depth information of the hole region through a texture synthesis method and an inpainting method.

The image processing apparatus may generate reference layer images based on a result of the restoring of the hole region. The image processing apparatus may generate a first reference layer image by filling the hole region with a color value having a similar attribute in the 2D color image or a color value of the background, and similarly generate a second reference layer image by filling the hole region with a depth value having a similar attribute in the depth image. The first reference layer image may include the color information of the hole region, and the second reference layer image may include the depth information of the hole region.

In operation 140, the image processing apparatus generates a 3D image to be displayed. In response to the presence of the hole region, the image processing apparatus may render the 3D image based on the 2D color image, the depth image, the first reference layer image, and the second reference layer image. The image processing apparatus may determine a view direction of each image pixel included in the 2D color image based on depth information of the depth image, and allocate a color value of a corresponding image pixel to a location of at least one display pixel corresponding to the determined view direction. An image pixel may refer to a region (e.g., a pixel) of a 3D image to be displayed on a screen. A display pixel may refer to a physical pixel on the screen where the 3D image is to be displayed. In addition, the image processing apparatus may determine a view direction of each pixel included in a hole region of the first reference layer image based on depth information of the second reference layer image, and allocate a color value of a corresponding image pixel to a location of at least one display pixel corresponding to the determined view direction. In response to an absence of the hole region, the image processing apparatus may render the 3D image based on the 2D color image and the depth image without considerations about the hole region.

In generating the 3D image, the image processing apparatus may render (e.g., directly render) the 3D image in a light field space without a process of generating a multiview image as an intermediate process. The image processing apparatus may generate the 3D image by allocating a color value of a corresponding image pixel to a single display pixel or a plurality of display pixels, or a location in the 3D image, determined based on a view direction of the image pixel. For example, the image processing apparatus may generate the 3D image by allocating (e.g., directly allocating) a color value of an image pixel to a location of a display pixel based on view information of the display pixel and a disparity corresponding to the image pixel in the 2D color image. The view information of the display pixel may include location information of the display pixel and view direction information of the display pixel. The image processing apparatus may match (e.g., directly match) a color value of the 3D image to a display pixel without generating the multiview image as an intermediate image, and thus may reduce an amount of resources required for rendering the 3D image and reduce a level of complexity.

A process of generating a 3D image will be described in more detail with reference to FIG. 2.

In operation 150, the image processing apparatus selectively performs light field-based image post-processing. For example, the image processing apparatus may detect a boundary region between a foreground and a background in the 2D color image, blend a color value of the foreground and a color value of the background, which are adjacent to the boundary region, based on a weighted value, and allocate the blended color value to a location in the 3D image corresponding to the boundary region. In another example, when a location in the 3D image corresponding to a view direction of an image pixel of the 2D color image is included in a smoothing region, the image processing apparatus may allocate a smoothed color value, in lieu of an original color value, to the location in the 3D image. Through such an image post-processing process, a quality of the 3D image may be improved.

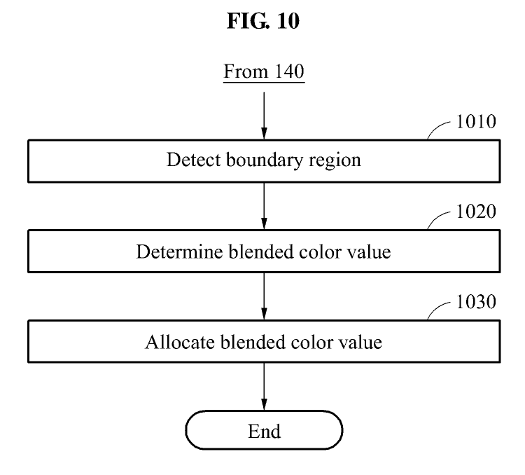

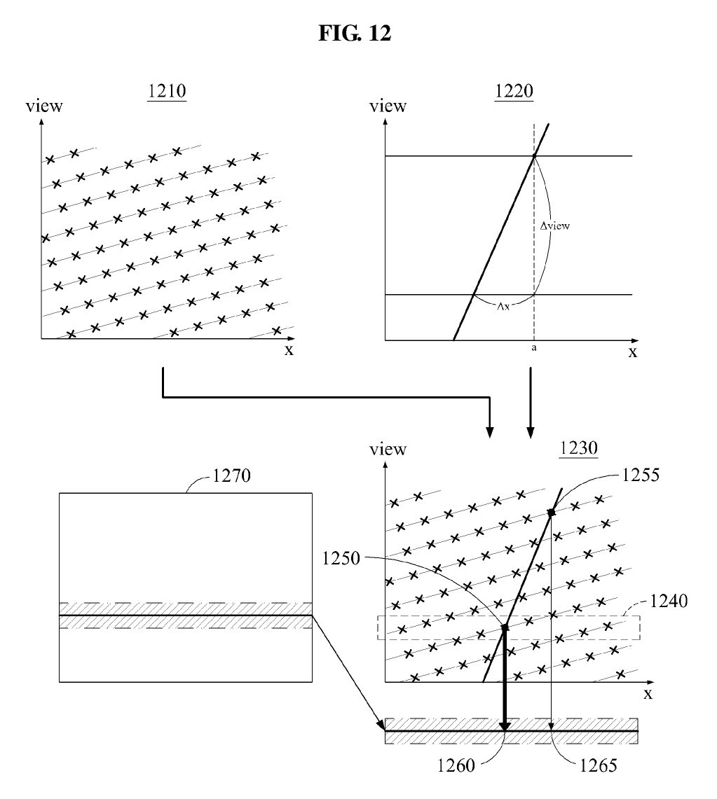

A process of performing image post-processing will be described in more detail with reference to FIGS. 10 and 12.

FIG. 2 is a flowchart illustrating a process of generating a 3D image according to at least one example embodiment. When a hole region is present, the image processing apparatus performs operations 210 through 240.

Referring to FIG. 2, in operation 210, the image processing apparatus determines a view direction of an image pixel corresponding to a hole region in a first reference layer image based on depth information of the hole region. The view direction of the image pixel may be determined based on a disparity corresponding to the image pixel, and the disparity may be determined based on depth information of a second reference layer image. A disparity function associated with a light ray to be output from an image pixel may be determined for each image pixel corresponding to the hole region. The disparity function refers to a light field expression by the image pixel and the disparity of the image pixel.

In operation 220, the image processing apparatus allocates a color value of the image pixel to a location of a display pixel corresponding to the view direction determined in operation 210. The image processing apparatus may determine the location of the display pixel to which the color value of the image pixel is to be allocated, using a first model associated with a view direction of the display pixel and a second model associated with the view direction of the image pixel.

The first model, which is a model based on a correlation between a location of a display pixel and a view direction of the display pixel, indicates a function associated with a view direction or a view location of a light ray output from each display pixel of a display device configured to display a 3D image. View information about the view direction of each display pixel may be prestored (or alternatively, retrieved upon request), and the image processing apparatus may determine the first model based on the view information.

According to at least one example embodiment, the first model may be determined based on a view direction of display pixels included in one line of a vertical direction and a horizontal direction among all display pixels. The image processing apparatus may set a plurality of reference points indicating a correlation between locations of display pixels and view directions or view locations of the display pixels, and determine the first model by determining an intermediate function passing through the set reference points. For example, the image processing apparatus may determine, to be the intermediate function, a set of linear functions passing through the reference points and having an equal inclination. The reference points may be set as a unit of display pixels located in one line of the vertical direction among all the display pixels or a unit of display pixels located in one line of the horizontal direction among all the display pixels. For example, the reference points may be set as a unit of display pixels located in one row or a unit of display pixels located in one column among all the display pixels.

The second model, which is a model obtained by modeling a direction of a light ray to be output from an image pixel based on a location of the image pixel, indicates a function associated with a view direction or a view location of the light ray to be output from the image pixel. The image processing apparatus may determine the view direction or the view location of the light ray to be output from the image pixel based on a disparity of the image pixel. The image processing apparatus may determine the second model by determining a disparity function, which is the function associated with the view direction of the light ray to be output from the image pixel. The second model may be determined for each image pixel.

The image processing apparatus may determine the display pixel to which the color value of the image pixel is to be allocated using a correlation between the first model and the second model, and allocate the color value of the image pixel to the determined display pixel. According to at least one example embodiment, the image processing apparatus may determine an intersection between the intermediate function and the disparity function, and determine a single display pixel or a plurality of display pixels to which the color value of the image pixel is to be allocated based on the determined intersection between the intermediate function and the disparity function. For example, the image processing apparatus may determine a reference point located closest to the intersection between the intermediate function and the disparity function among reference points included in the intermediate function, and allocate a color value of a corresponding image pixel to a location of a display pixel corresponding to the determined reference point.

As described above, a hole region may compensated for in a 3D image through a prediction of a hole region based on a 2D color image, and restoring of information about the hole region and applying the information to the 3D image.

In operation 230, the image processing apparatus determines a view direction of an image pixel of the 2D color image based on the depth image corresponding to the 2D color image. The view direction of the image pixel of the 2D color image may be determined based on a disparity of the image pixel of the 2D color image. A disparity function associated with a light ray output from each image pixel included in the 2D color image may be determined for each image pixel.

In operation 240, the image processing apparatus allocates a color value of the image pixel of the 2D color image to a location of a display pixel corresponding to the view direction of the image pixel of the 2D color image. The image processing apparatus may determine the location of the display pixel corresponding to the view direction of the image pixel of the 2D color image using a first model associated with a view direction of a display pixel and a second model associated with a view direction of an image pixel of the 2D color image. The image processing apparatus may perform, on other image pixels of the 2D color image, an image processing process similar to operations 210 and 220 to configure a color value of a 3D image.

In operations 220 and 240, the image processing apparatus repetitively performs the operations described above on display pixels and image pixels located at different lines to generate a 3D image to be displayed.

In response to an absence of the hole region, the image processing apparatus may perform operations 230 and 240 without performing operations 210 and 220 to generate a 3D image.

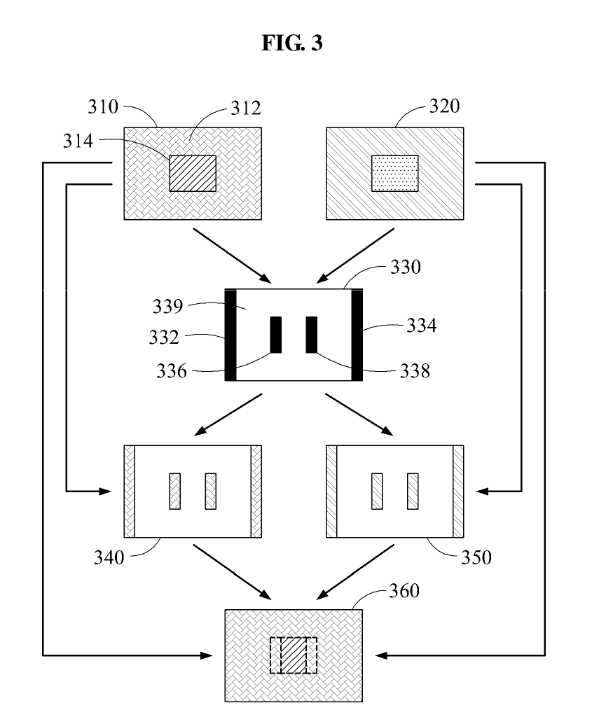

FIG. 3 is a diagram illustrating a process of generating a 3D image according to at least one example embodiment.

Referring to FIG. 3, a 2D color image 310, which is an input image, includes a foreground 314 and a background 312. In general, the foreground 314 may have a greater disparity, or a smaller depth, than the background 312. A depth image 320 corresponding to the 2D color image 310 may include depth information associated with the foreground 314 and depth information associated with the background 312.

As illustrated in FIG. 3, an image processing apparatus may estimate a hole region, for example, a hole region 332, a hole region 334, a hole region 336, and a hole region 338, based on the 2D color image 310, the depth image 320, and a stereoscopic parameter, and generate a hole map 330 including the hole regions 332, 334, 336, and 338 and a non-hole region 339. A distance difference between the foreground 314 and the background 312 may be determined based on the stereoscopic parameter, and the hole region may be determined based on the distance difference. For example, the hole map 330 may be configured as a binary map in which the hole regions 332, 334, 336, and 338 are expressed as 0 and the non-hole region 339 as 1.

The image processing apparatus may generate a reference layer image, for example, a first reference layer image 340 and a second reference layer image 350, by restoring the hole regions 332, 334, 336, and 338 of the hole map 330. For example, information about the hole regions 332, 334, 336, and 338 may be restored through various hole filling methods, for example, texture synthesis and inpainting. The image processing apparatus may estimate color information of the hole regions 332, 334, 336, and 338 based on the 2D color image 310 and the hole map 330, and generate the first reference layer image 340 including the color information of the hole regions 332, 334, 336, and 338. For example, the hole regions 332, 334, 336, and 338 in the first reference layer image 340 may be filled based on a color value of a background adjacent to each of the hole regions 332, 334, 336, and 338.

In addition, the image processing apparatus may estimate depth information of the hole regions 332, 334, 336, and 338 based on the depth image 320 and the hole map 330, and generate the second reference layer image 350 including the depth information of the hole regions 332, 334, 336, and 338. For example, the hole regions 332, 334, 336, and 338 in the second reference layer image 350 may be filled based on a depth value of a background adjacent to each of the hole regions 332, 334, 336, and 338.

The image processing apparatus may render a 3D image 360 in a light field space based on the first reference layer image 340 and the second reference layer image 350, which are associated with the restored hole region, and on the 2D color image 310 and the depth image 320. The image processing apparatus may determine a location in the 3D image 360 to which a color value of each image pixel of the 2D color image 310 is to be allocated based on depth information, or disparity information, indicated in the depth image 320, and allocate a color value of a corresponding image pixel to the determined location. In addition, the image processing apparatus may determine a location in the first reference layer image 340 to which a color value of an image pixel in the hole region is to be allocated based on depth information indicated in the second reference layer image 350, and allocate the color value of the image pixel to the determined location. Through the process described above, the 3D image 360 to be displayed may be generated based on results of the allocating of such color values.

FIG. 4 is a diagram illustrating a process of generating a hole map 330 according to at least one example embodiment. Referring to FIG. 4, a disparity difference of each image pixel in a 2D color image 310 and a depth image 320 may be calculated to estimate a hole region. The disparity difference may include a left difference ΔdL and a right difference ΔdR. The left difference refers to a difference associated with an image pixel adjacent to a corresponding image pixel in a left side, hereinafter simply referred to as a left image pixel. The right difference refers to a difference associated with an image pixel adjacent to a corresponding image pixel in a right side, hereinafter simply referred to as a right image pixel.

A disparity of a horizontal line 410 in the depth image 320 is illustrated as a graph 420. Using a disparity difference illustrated in the graph 420, a region occluded by a foreground 314 of the 2D color image 310 may be determined to be the hole region. The hole map 330 may be generated based on the disparity difference, for example, the left difference and the right difference, of image pixels in the 2D color image 310.

An example of a method of determining the region occluded by the foreground 314, for example, image pixels set to be a hole region, will be described hereinafter.

When a first disparity of a first image pixel is greater than a second disparity of a second image pixel adjacent to the first image pixel in a left side by a value greater than or equal to a threshold value, for example, when ΔdL of the first image pixel is greater than the threshold value, α·ΔdL image pixels in a right side from the first image pixel may be set to be a hole region. The number of the image pixels set to be the hole region may be proportional to a difference between the first disparity and the second disparity.

Similarly, when the first disparity of the first image pixel is greater than a third disparity of a third image pixel adjacent to the first image pixel in a right side by a value greater than or equal to a threshold value, for example, when ΔdR of the first image pixel is greater than the threshold value, α·ΔdR image pixels in a left side from the first image pixel may be set to be a hole region. The number of the image pixels set to be the hole region may be proportional to a difference between the first disparity and the third disparity.

A first region 430 and a second region 440 indicate a hole region to be generated based on a disparity difference of image pixels, for example, a region determined to be occluded by the foreground 314. A second graph 450 indicates a method through which the first region 430 and the second region 440 are set or calculated in proportion to the difference, for example, ΔdL and ΔdR, and a value of α. Here, “α” denotes a constant.

As described above, a hole region may be estimated from an input image and a hole map may be generated.

FIG. 5 is a diagram illustrating a configuration of a 3D display device 500 according to at least one example embodiment. Referring to FIG. 5, the 3D display device 500 includes an image processing apparatus 510, a display panel 560 including a plurality of display pixels, and a lenticular lens 570. The image processing apparatus 510 includes a processor 520, a memory 530, a gate driver 540, and a signal driver 550.

The processor 520 may generate a 3D image to be output through the display panel 560 by executing instructions stored in the memory 530. The processor 520 may provide the gate driver 540 and the signal driver 550 with timing information for selecting the display pixels and allocated pixel value information. The image processing apparatus 510 may determine a first model using information associated with the display pixels. For example, the information associated with the display pixels may include location information about a location of each display pixel in the display panel 560 and information associated with a view direction of each display pixel.

Each of the display pixels included in the display panel 560, for example, a first display pixel 582, a second display pixel 584, a third display pixel 586, a fourth display pixel 588, and a fifth display pixel 590, may have a desired (or alternatively, preset) view direction. The display panel 560 may display the 3D image through the display pixels 582, 584, 586, 588, and 590 having the desired (or alternatively, preset) view direction. The view direction of the display pixels 582, 584, 586, 588, and 590 may be determined by the lenticular lens 570. The view direction of the display pixels 582, 584, 586, 588, and 590 may have periodicity or repeatability in a unit of a display pixel group based on a structural characteristic of the lenticular lens 570. A moving path of a light ray to be radiated from each of the display pixels 582, 584, 586, 588, and 590 may be determined based on the structural characteristic of the lenticular lens 570.

For example, a moving path of a light ray to be output from each of the display pixels 582, 584, 586, 588, and 590 may be determined based on a distance between the lenticular lens 570 and a display pixel, a pitch and an inclination of the lenticular lens 570, a lenticular characteristic of a light ray being refracted, and the like. A light ray output from each of the display pixels 582, 584, 586, 588, and 590 may be refracted or pass through the lenticular lens 570 to move towards a location in a 3D space, and a moving direction of the light ray may correspond to a view direction of each of the display pixels 582, 584, 586, 588, and 590.

Each of the display pixels 582, 584, 586, 588, and 590 may have one view direction among a preset number of different view directions, and the view direction may be preset in a process of designing the 3D display device 500. For example, the 3D display device 500 may express a first view direction through N-th view direction, in which “N” denotes a natural number greater than 1, and each of the display pixels 582, 584, 586, 588, and 590 included in the 3D display device 500 may have one view direction among the first through N-th view directions.

In addition, pixel information as to which view direction a pixel moves towards may be determined (e.g., predetermined) for each of the display pixels 582, 584, 586, 588, and 590. For example, for the 3D display device 500 to normally display a 3D image, pixel information of a first view direction, pixel information of a second view direction, pixel information of a third view direction, pixel information of a fourth view direction, pixel information of a fifth view direction may be determined (e.g., predetermined) for each of the display pixels 582, 584, 586, 588, and 590 based on the structural characteristic of the lenticular lens 570. Here, the pixel information refers to image information in a unit of a pixel included in an output image to be output through a display pixel.

A light ray to be output from the first display pixel 582 may move in the first view direction via the lenticular lens 570, and a light ray to be output from the second display pixel 584 may move in the second view direction via the lenticular lens 570. Similarly, a light ray to be output from the third display pixel 586 may move in the third view direction via the lenticular lens 570, a light ray to be output from the fourth display pixel 588 may move in the fourth view direction via the lenticular lens 570, and a light ray to be output from the fifth display pixel 590 may move in the fifth view direction via the lenticular lens 570.

Thus, based on the structural characteristic of the lenticular lens 570, view directions of the display pixels may have periodicity or repeatability. For example, display pixels located in one column of the display panel 560 may have a pattern in which the first view direction, the second view direction, the third view direction, the fourth view direction, and the fifth view direction are continuously repeated.

According to at least one example embodiment, the 3D display device 500 may include a parallax barrier in lieu of the lenticular lens 570 to represent a 3D effect of a 3D image, or include both the lenticular lens 570 and the parallax barrier.

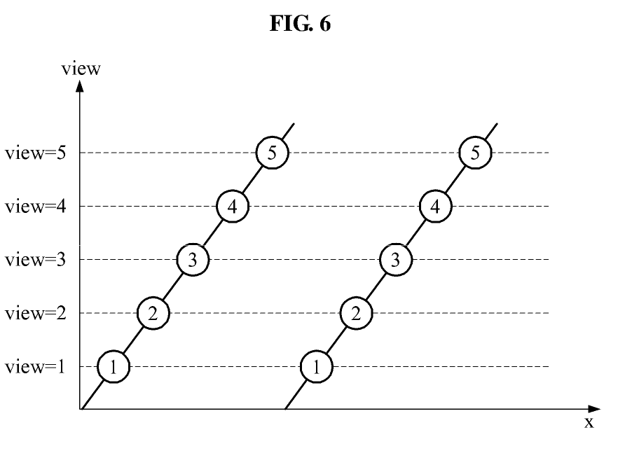

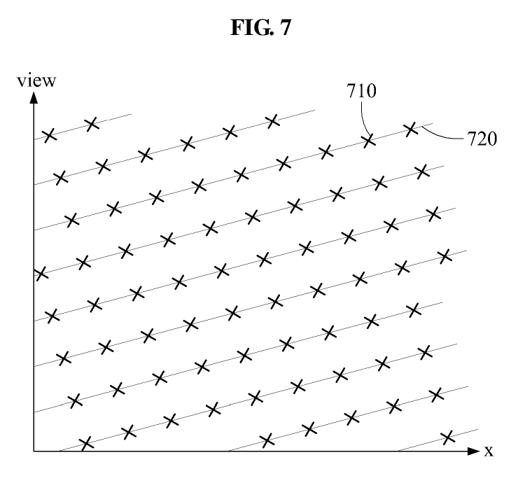

FIGS. 6 and 7 are diagrams illustrating a first model according to at least one example embodiment.

A first model corresponding to a light field function of a 3D display device may be determined based on a correlation between a location of each display pixel and a view direction of each display pixel. FIG. 6 is a graph indicating the correlation between a location of each display pixel and a view direction of each display pixel. In the graph, the x axis indicates a location of a display pixel and the y axis indicates a view direction of the display pixel. Here, for convenience of description, it is assumed that the number of view directions of a display pixel is five. In the graph, a point corresponding to a location of a display pixel and a view direction of the display pixel is defined as a reference point.

The first model may be determined based on display pixels arranged on a line. In FIG. 6, 10 reference points indicating a correlation between respective locations of 10 display pixels and respective view directions of the 10 display pixels are illustrated. Here, the reference point indicates a light ray expressed by the 3D display device. The 3D display device may output the light ray based on a light field having a certain structure because the 3D display device is not always capable of expressing all light rays in a real world.

FIG. 7 is a diagram illustrating a light field of a 3D display device displaying a stereoscopic image using a lenticular lens. In FIG. 7, the light field of the 3D display device is indicated as “X,” and each X corresponds to a reference point 710. The light field of the 3D display device may be determined based on a location of each display pixel included in the 3D display device and a view direction of a light ray to be output from each display pixel included in the 3D display device. In the graph illustrated in FIG. 7, the x axis indicates a location of a display pixel located on one line in a vertical direction or a horizontal direction, and the y axis indicates a view direction of the display pixel.

Since the 3D display device uses a limited light source, for example, a subpixel, not an infinite number of display pixels, the light field of the 3D display device may be expressed as the reference point 710 sampled as X in FIG. 7. The reference point 710 may be determined based on a view direction of each display pixel of the 3D display device. An image processing apparatus may generate a 3D image by generating a light field of display pixels corresponding to the reference point 710.

A continuous light field function f_{LF}(x) expressed by the 3D display device may be represented as in Equation 1.

$${f}_{LF} ( x ) = \frac{f - D}{f} x + \frac{D}{f} {υ}_{n} ( x ) \qquad [ Equation 1 ]$$

In Equation 1, “x” denotes a variable to identify a location of each display pixel included in one line in a vertical direction or a horizontal direction among display pixels included in the 3D display device. “f” denotes a focal distance of the lenticular lens, and “D” denotes a viewing distance from the 3D display device. “vn(x)” denotes a view location at which a light ray output from a display pixel at an x location arrives after passing through an n-th lenticule (or lens) of the lenticular lens.

For example, the reference point 710 may be represented as in Equation 2.

$${f}_{LF} ( i , s ) = mod ( \frac{f - D}{f} x ( s ) + \frac{D}{f} {υ}_{s} ( i ) + {V}_{L} , V ) + {V}_{R} \qquad [ Equation 2 ]$$

In Equation 2, “f_{LF}(i,s)” indicates a light field function of the 3D display device having a sampled value. The sampled value may correspond to the reference point 710. Equation 2 redefines Equation 1 based on a viewing area V and a characteristic of the lenticular lens. The light field function of the 3D display device using the lenticular lens may have a discrete form as in Equation 2. The viewing area V indicates an area between a view location of a left eye VL and a view location of a right eye VR. “f” denotes a focal distance of the lenticular lens, and “D” denotes a viewing distance from the 3D display device. “mod(a,b)” indicates a function for outputting a remainder from division of “a” by “b.”

“i” denotes an index to identify a location of a display pixel included in one line in a vertical direction or a horizontal direction among the display pixels included in the 3D display device, and has a value of 1, 2, . . . , n, wherein “n” denotes a natural number. “s” denotes a variable having i*3 dimensions, and has a value of 1, 2, . . . , m, wherein “m” denotes a natural number. “x(s)” denotes a location value of a display pixel based on a value of “s.” “vs(i)” denotes a view location at which a light ray output from an i-th display pixel arrives after passing through an s-th lenticule (or lens) of the lenticular lens. In a case of the lenticular lens having a diagonally inclined form, a starting point of a lenticule “v1(s=1)” may vary depending on a value of “i,” and thus “vs(i)” is expressed as a function of i.

A view direction of a display pixel may be indicated as a pattern based on a location index to identify the display pixel in the 3D display device and a view index to identify a view direction of the display pixel. The pattern indicating the view direction of the display pixel based on the location index and the view index of the display pixel is defined as a weaving pattern. The weaving pattern indicates a view direction or a view location of display pixels located on one line in the vertical direction or the horizontal direction in the 3D display device. The weaving pattern may include the reference point 710, which is a plurality of reference points, indicating the correlation between the location and the view direction of the display pixel. Using the periodicity based on the structural characteristic of the lenticular lens, a view direction corresponding to each display pixel may be indicated as a pattern illustrated in FIG. 7.

The image processing apparatus may determine an intermediate function 720 based on the reference point 710 indicating a view direction of a display pixel. The intermediate function 720 may be expressed as a function passing through a single reference point or a plurality of reference points. The first model associated with the display pixels may be determined by a plurality of intermediate functions passing through the reference point 710. According to at least one example embodiment, the image processing apparatus may determine an intermediate function based on Equation 3. Based on Equation 3, the intermediate function may be defined as a plurality of linear functions passing through a reference point.

f_{WP}(s,p,i)=a_{WP}(s−aₚp)+b_{WP}(i) [Equation 3]

In Equation 3, “p” denotes a variable used to group a weaving pattern into a plurality of linear functions, and has a value of 1, 2, . . . , q, wherein “q” denotes a natural number. “i” denotes an index to identify a location of a display pixel included in one line in a vertical direction or a horizontal direction among the display pixels of the 3D display device, and has a value of 1, 2, . . . , n, wherein “n” denotes a natural value. “s” denotes a variable having i*3 dimensions, and has a value of 1, 2, . . . , m, wherein “m” denotes a natural value. “f_{WP}(s,p,i)” indicates an intermediate function to be determined based on the values s, p, and i. “a_{WP}” denotes an inclination of f_{WP}(s,p,i), and may be defined as in Equation 4.

$${a}_{WP} = \frac{{f}_{LF} ( i , c + {n}_{WP} ) - {f}_{LF} ( i , {n}_{WP} )}{{n}_{WP}} \qquad [ Equation 4 ]$$

In Equation 4, “f_{LF}(,)” corresponds to a light field function of the 3D display device having the sampled value in Equation 2. “i” denotes an index to identify a location of a display pixel included in one line in a vertical direction or a horizontal direction among the display pixels included in the 3D display device, and has a value of 1, 2, . . . , n, wherein “n” denotes a natural value. “c” denotes a general constant, and has a value of 1, 2, . . . , w, wherein “w” denotes a natural number. “n_{WP}” denotes a separation distance, in an s direction, between neighboring reference points among reference points included in the same intermediate function.

“b_{WP}(i)” denotes a y-intercept of the f_{WP}(s,p,i) function based on a value of i, and may be defined as in Equation 5.

b_{WP}(i)=f_{LF}(i,1)−a_{WP} [Equation 5]

In Equation 5, “f_{LF}(,)” corresponds to a light field function of the 3D display device having the sampled value in Equation 2. “a_{WP}” corresponds to an inclination of the intermediate function f_{WP}(s,p,i) to be determined based on the values s, p, and i in Equation 4.

In Equation 3, “a_{P}” indicates how far neighboring intermediate functions are separated from one another among the intermediate functions 520 indicated by f_{WP}(s,p,i), and may be defined as in Equation 6.

$${a}_{p} = \frac{{a}_{WP} {n}_{mr} - ( {f}_{LF} ( i , c + {n}_{mr} ) - {f}_{LF} ( i , c ) )}{{a}_{WP}} \qquad [ Equation 6 ]$$

In Equation 6, “f_{LF}(,)” corresponds to a light field function of the 3D display device having the sampled value in Equation 2, and “a_{WP}” corresponds to an inclination of the intermediate function fWP(s,p,i) to be determined based on the values s, p, and i in Equation 4. “c” denotes a general constant, and has a value of 1, 2, . . . , w, wherein “w” denotes a natural value. “nmr” denotes a separation distance between starting points of intermediate functions based on a value of p in the fWP(s,p,i) in Equation 3. For example, when a starting point of an intermediate function in which a value of p is 1 (p=1) is assumed as “a,” a starting point of an intermediate function in which a value of p is 2 (p=2) is “a+nmr.”

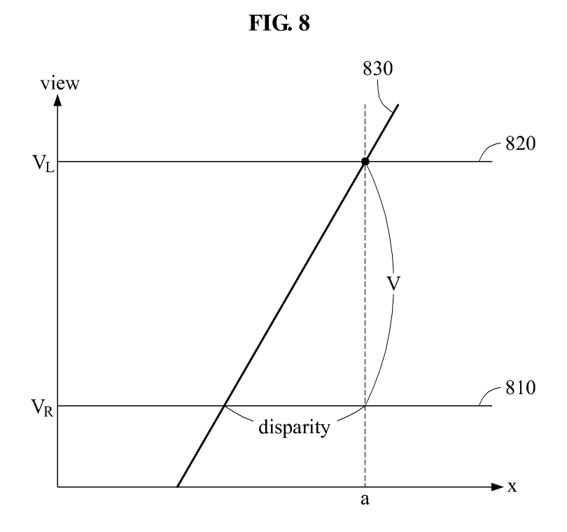

FIG. 8 is a diagram illustrating a second model according to at least one example embodiment.

An image obtained by capturing a light ray at a view in a space by a camera may be input to an image processing apparatus as an input image. A light field of the input image may be expressed through various methods. The light field of the input image may be determined based on a location of an image pixel in the input image and a view direction of a light ray to be output from the image pixel. The view direction of the light ray to be output from the image pixel may be determined based on a disparity of the image pixel.

When a distance between a left view and a right view is assumed as a viewing area V, a light field of an image pixel having a color value and a disparity in the input image may be modeled with a disparity function, which is a straight line equation having an inclination ‘V/disparity’ and passing through an original image location. In the graph illustrated in FIG. 8, a disparity function 830 is illustrated as a straight line equation having an inclination of ‘V/disparity’ and passing through an original image location (a, VL). Here, “VL” 820 indicates a view location of a left eye in the viewing area V, and “VR” 810 indicates a view location of a right eye in the viewing area V.

The image processing apparatus may determine the disparity function 830 expressed by the image pixel and the disparity of the image pixel based on the disparity of the image pixel of the input image. A second model associated with the image pixel may be determined based on the disparity function 830 of the image pixel.

For example, the image processing apparatus may determine a disparity function of an image pixel located at (i, j) based on Equation 7.

$${f}_{D} ( s , i , j ) = \frac{V}{3 d ( i , j )} ( s - 3 j ) + {V}_{L} \qquad [ Equation 7 ]$$

In Equation 7, if a distance between a left view V_{L} and a right view V_{R} is a viewing area V and an input image is a left image, the image processing apparatus may determine, to be a disparity function, a straight line equation having an inclination of V between disparities in an x direction and passing through an original location (3j, VL) of an image pixel. Equation 7 indicates a disparity function of an image pixel at a location (i, j) in an input image. Here, “i” denotes an index to identify a location of the image pixel in a row of the input image, and “j” denotes an index to identify a location of the image pixel in a column of the input image. “s” denotes a variable to match a light field function and a dimension of a display device when a location of a display pixel is set based on three subpixels, for example, an R subpixel, a G subpixel, and a B subpixel, and has j*3 dimensions. “d” denotes a disparity of the image pixel at the location (i, j) in the input image.

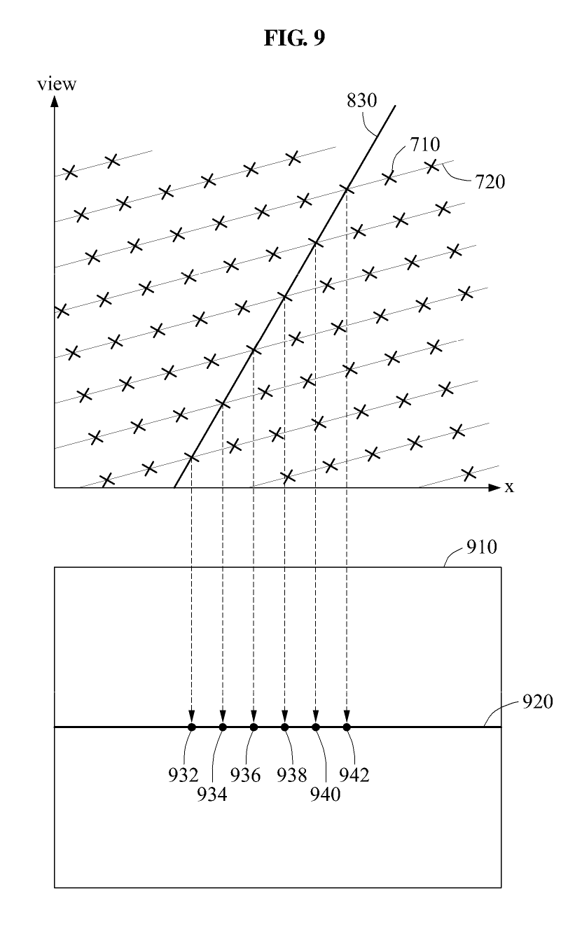

FIG. 9 is a diagram illustrating a process of rendering a 3D image based on a first model and a second model according to at least one example embodiment.

An image processing apparatus may render a 3D image based on a first model associated with a display pixel and a second model associated with an image pixel. The image processing apparatus may allocate a color value of an image pixel to a single display pixel or a plurality of display pixels having a view direction corresponding to a view direction of the image pixel.

Referring to FIG. 9, a 3D image 910 to be output through display pixels included in a display panel may be rendered in a unit of a line, for example, a line 920. A first model associated with display pixels corresponding to a location of the line 920 of the 3D image 910 may be determined. The image processing apparatus may determine the first model based on locations of the display pixels disposed on the line 920 and view directions of the display pixels. The first model may be determined by the intermediate function 720 determined based on Equations 3 through 6, and the intermediate function 720 refers to a function connecting the reference point 710 illustrated in FIG. 7.

The image processing apparatus may determine a second model based on a disparity function 830 associated with one image pixel among image pixels present in a location in an input image corresponding to the line 920. The second model may be determined based on Equation 7.

The image processing apparatus may determine an intersection between the intermediate function 720 and the disparity function 830. The image processing apparatus may determine a display pixel corresponding to the intersection and allocate, to the determined display pixel, a color value of an image pixel subject to the disparity function 830.

According to at least one example embodiment, the image processing apparatus may determine a reference point closest to the intersection, and allocate the color value of the image pixel subject to the disparity function 830 to a display pixel corresponding to the determined reference point. The image processing apparatus may repetitively perform the process described in the foregoing on all intersections between the intermediate function 720 and the disparity function 830. Since the reference point 710 has a periodicity due to a structural characteristic of a lenticular lens, other intersections may be determined based on a difference between two intersections.

According to at least one other example embodiment, the disparity function 830 may be expressed as a region, and the image processing apparatus may identify a reference point included in the region indicated by the disparity function 830 and allocate the color value of the image pixel subject to the disparity function 830 to a display pixel corresponding to the identified reference point.

As illustrated in FIG. 9, six reference points corresponding to the intersection between the intermediate function 720 and the disparity function 830 are determined, and the color value of the image pixel subject to the disparity function 830 may be allocated to locations of respective display pixels corresponding to the six reference points, for example, a location 932, a location 934, a location 936, a location 938, a location 940, and a location 942.

For example, when the disparity function 830 is associated with an image pixel A, a color value of the image pixel A may be allocated to the locations 932, 934, 936, 938, 940, and 942 of the display pixels. Afterwards, a second model associated with another image pixel B, not the image pixel A, among the image pixels present at the location in the input image corresponding to the line 920 may be determined, and a display pixel to which a color value of the image pixel B is to be allocated may be determined based on the first model associated with the display pixels corresponding to the location of the line 920 and the second model associated with the image pixel B. The second model associated with the image pixel B may be determined based on a disparity estimated for the image pixel B.

When the process described in the foregoing is performed on the image pixels present at the location corresponding to the line 920, the image processing apparatus may determine a first model associated with display pixels located on a line subsequent to the line 920, and may continuously perform the process described in the foregoing on image pixels present at a location corresponding to the subsequent line. As described above, the image processing apparatus may render (e.g., directly render) a stereoscopic image without generating a multiview image by mapping (e.g., directly mapping), to a display pixel, a color value of each image pixel included in an input image, and thus may reduce an amount of calculation and resources used in a process of rendering the stereoscopic image.

FIG. 10 is a flowchart illustrating a process of performing light field-based image post-processing according to at least one example embodiment.

Referring to FIG. 10, in operation 1010, an image processing apparatus detects a boundary region between a foreground and a background in a 2D color image. The image processing apparatus may determine, to be the boundary region, a region in which a depth difference is present based on depth information of a depth image corresponding to the 2D color image.

In operation 1020, the image processing apparatus determines a blended color value by blending a color value of the foreground and a color value of the background, which are adjacent to the boundary region. For example, the image processing apparatus may blend a color of the foreground and a color of the background based on Equation 8.

C=αF+(1−α)B [Equation 8]

In Equation 8, “F” denotes a color value of a foreground, and “B” denotes a color value of a background. “α” denotes a weighted value, and “C” denotes a blended color value.

In operation 1030, the image processing apparatus allocates the blended color value to a location of a display pixel corresponding to the boundary region. The image processing apparatus may determine a location in a 3D image corresponding to a view direction of an image pixel included in the boundary region, and allocate the blended color value to the determined location.

Through the process described in the foregoing, a 3D image having a natural boundary region between a foreground and a background may be generated.

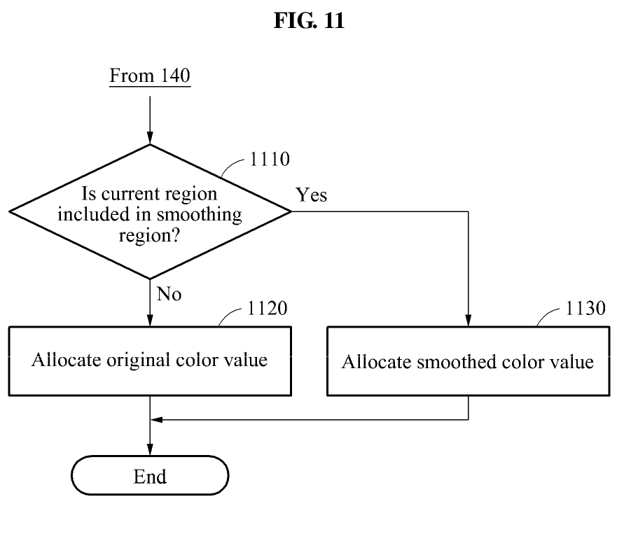

FIGS. 11 and 12 are a flowchart and a diagram illustrating a process of performing light field-based image post-processing according to at least another example embodiment. An image processing apparatus may selectively perform a smoothing process on a 3D image. To calibrate a region in which an artifact occurs in a 3D image to be output, the image processing apparatus may reduce occurrence of an artifact by replacing, with a smoothed color value, a color value of the region in which the artifact is to occur.

Referring to FIG. 11, in operation 1110, the image processing apparatus determines whether a current region to which a color value of an image pixel is to be allocated is included in a smoothing region. Here, the image pixel is associated with one of an image pixel corresponding to a hole region and an image pixel in a 2D color image. The smoothing region refers to a region to which a smoothed color value is to be allocated, and may be determined by a user.

In operation 1120, in response to a determination that the current region is included in the smoothing region, the image processing apparatus allocates the smoothed color value to the current region. For example, the image processing apparatus may determine, to be the smoothed color value, a mean value of color values of a region adjacent to the current region. In operation 1130, in response to a determination that the current region is not included in the smoothing region, the image processing apparatus allocates an original color value to a location to which the color value of the image pixel is to be allocated.

FIG. 12 illustrates a first model 1210 associated with a display pixel as a light field of a 3D display device as described with reference to FIG. 7, and a second model 1220 associated with an image pixel as described with reference to FIG. 8. An image processing apparatus may determine an intersection between the first model 1210 and the second model 1220 in a process of rendering a 3D image, and determine whether a current region corresponding to the intersection is included in a smoothing region. The image processing apparatus may allocate a smoothed color value to a location to which a color value is to be allocated when the current region is determined to be included in the smoothing region, and may allocate an original color value to the location to which the color value is to be allocated when the current region is determined not be included in the smoothing region.

For example, as shown in 1230, an intersection 1250 between the first model 1210 and the second model 1220 is located in a smoothing region 1240, and thus the image processing apparatus may allocate a smoothed color value to a region 1260 in a 3D image 1270 corresponding to a location of the intersection 1250. Conversely, an intersection 1255 is not included in the smoothing region 1240, the image processing apparatus may allocate an original color value to a region 1265 in the 3D image 1270 corresponding to a location of the intersection 1255.

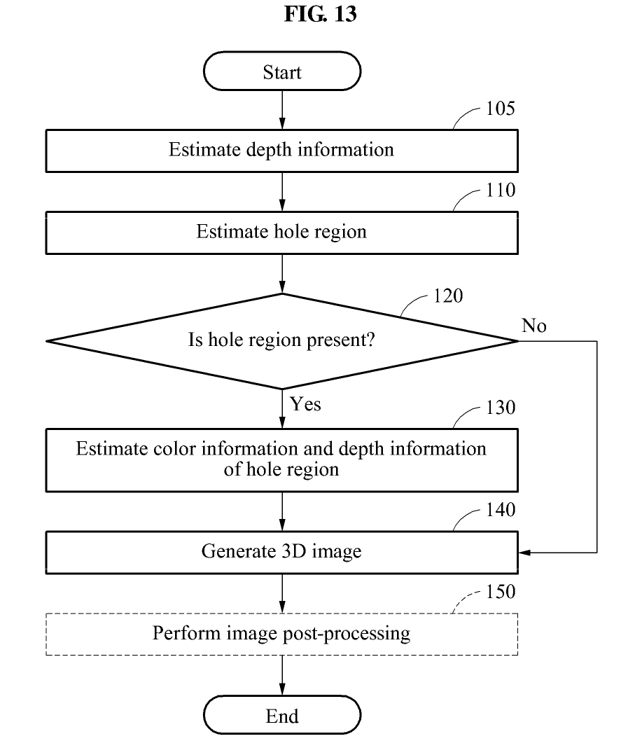

FIG. 13 is a flowchart illustrating an image processing method according to at least another example embodiment. When a depth image is not input, an image processing apparatus may generate the depth image through image processing. Referring to FIG. 13, in operation 105, the image processing apparatus estimates depth information from an input image based on a disparity difference.

In a case of the input image being a single 2D color image, the image processing apparatus may estimate the depth information using a 2D to 3D conversion method. For example, the image processing apparatus may estimate the depth information by analyzing color information of the input image and performing a method, for example, salient feature extraction and texture analysis.

In a case of the input image being a stereo image, the image processing apparatus may estimate the depth information by performing stereo matching on the stereo image. The stereo matching refers to a method of obtaining the depth information using a view difference or a distance between corresponding image pixels in the stereo image. In a case of the input image being a multiview image, the image processing apparatus may estimate the depth information based on a view difference between multiview images. For example, the image processing apparatus may estimate the depth information, or disparity information, associated with all image pixels in the input image by calculating a distance between corresponding image pixels in the input image and a reference image, for example, a different view image. The estimated depth information may be expressed in a form of a depth map.

Operations 110 through 150 illustrated in FIG. 13 may correspond to operations 110 through 150 described with reference to FIG. 1, and thus a more detailed and repeated description is omitted here.

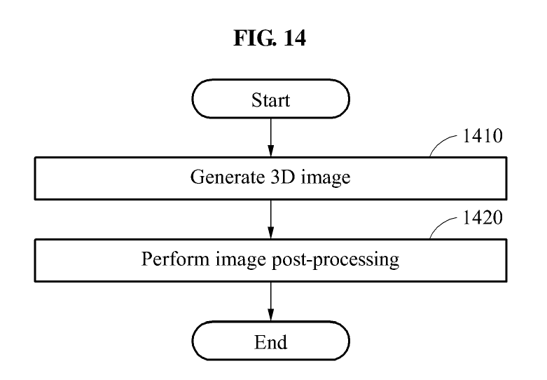

FIG. 14 is a flowchart illustrating an image processing method according to at least still another example embodiment.

Referring to FIG. 14, in operation 1410, if an input image is a layered depth image (LDI), an image processing apparatus generates a 3D image based on the LDI without estimating and restoring a hole region. Here, for an operation of generating the 3D image, reference may be made to operations 230 and 240 described with reference to FIG. 2 and thus, a more detailed and repeated description is omitted here.

In operation 1420, the image processing apparatus performs image post-processing. The image processing apparatus may perform the image post-processing described with reference to FIGS. 10 through 12, and reference may be made to the descriptions provided with reference to FIGS. 10 through 12.

FIG. 15 is a diagram illustrating an image processing apparatus 1500 according to at least one example embodiment.

Referring to FIG. 15, the image processing apparatus 1500 includes at least one processor 1510 and a memory 1520. The processor 1510 may be a special purpose processor that performs at least one operation described with reference to FIGS. 1 through 14. For example, the processor 1510 may estimate and restore a hole region from an input image, and generate a 3D image by allocating a color value of an image pixel of the input image and the hole region to a location of a corresponding display pixel. Although the processor 1510 may be configured as an array of logic gates, it may be obvious to a person having ordinary skill in the art to which example embodiments described herein belongs that the processor 1510 may also be configured as hardware in another form.

The memory 1520 may store instructions, which when executed by the processor 1510, cause the processor 1510 to perform at least one operation described with reference to FIGS. 1 through 14, or store data and results obtained during an operation of the image processing apparatus 1500. According to at least one example embodiment, the memory 1520 may include non-transitory computer-readable media, for example, a high-speed random access memory and/or nonvolatile computer-readable recording media, for example, at least one disk device and flash memory device, or other nonvolatile solid state storage devices.

The units and/or modules described herein may be implemented using hardware components and software components. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An image processing method, comprising:
estimating a hole region based on a two-dimensional (2D) color image and a depth image corresponding to the 2D color image;
estimating color information and depth information of the hole region;
determining a view direction of an image pixel corresponding to the hole region based on the depth information of the hole region; and
allocating a color value of the image pixel to a location of a display pixel corresponding to the view direction.

2. The method of claim 1, wherein the allocating comprises:
determining the location of the display pixel using a first model associated with a view direction of the display pixel and a second model associated with the view direction of the image pixel.

3. The method of claim 2, wherein the first model is based on a correlation between the location of the display pixel and the view direction of the display pixel, and the second model is obtained by modeling a direction of a light ray to be output from the image pixel based on a location of the image pixel.

4. The method of claim 1, wherein the view direction of the image pixel corresponding to the hole region is based on a disparity corresponding to the image pixel.

5. The method of claim 1, further comprising:
determining a view direction of an image pixel corresponding to the 2D color image based on the depth image corresponding to the 2D color image; and
allocating a color value of the image pixel of the 2D color image to a location of a display pixel corresponding to the view direction of the image pixel of the 2D color image.

6. The method of claim 5, wherein the allocating a color value of the image pixel of the 2D color image comprises:
determining the location of the display pixel corresponding to the view direction of the image pixel of the 2D color image using a first model associated with a view direction of the display pixel and a second model associated with the view direction of the image pixel of the 2D color image.

7. The method of claim 6, further comprising:
generating a three-dimensional (3D) image based on a result of the allocating a color value of the image pixel corresponding to the hole region and a result of the allocating a color value of the image pixel of the 2D color image.

8. The method of claim 6, wherein the view direction of the image pixel of the 2D color image is based on a disparity corresponding to the image pixel of the 2D color image.

9. The method of claim 1, wherein the estimating a hole region comprises:
estimating the hole region based on the 2D color image, the depth image corresponding to the 2D color image, and a stereoscopic parameter.

10. The method of claim 1, wherein the estimating of the color information and the depth information of the hole region comprises:
estimating the color information and the depth information through at least one of texture synthesis and inpainting.

11. The method of claim 1, further comprising:
detecting a boundary region between a foreground and a background in the 2D color image;
determining a blended color value by blending a color of the foreground and a color of the background in the boundary region; and
allocating the blended color value to a location of a display pixel corresponding to the boundary region.

12. The method of claim 1, further comprising:
determining whether the location of the display pixel to which the color value of at least one of the image pixel corresponding to the hole region and the image pixel of the 2D color image is allocated is in a smoothing region; and
allocating the color value of the image pixel or a smoothed color value obtained by performing smoothing to the location of the display pixel based on a result of the determining.

13. The method of claim 1, wherein the 2D color image is one of a stereo image and a multiview image.

14. A non-transitory computer-readable medium comprising program code that, when executed by a processor, causes the processor to perform the method of claim 1.

15. An image processing apparatus, comprising:
at least one processor; and
at least one memory configured to store instructions, which when implemented by the processor, cause the processor to,
estimate a hole region based on a two-dimensional (2D) color image and a depth image corresponding to the 2D color image,
estimate color information and depth information of the hole region,
determine a view direction of an image pixel corresponding to the hole region based on the depth information of the hole region, and
allocate a color value of the image pixel to a location of a display pixel corresponding to the view direction.

16. The apparatus of claim 15, wherein the instructions cause the processor to:
determine a view direction of an image pixel of the 2D color image based on the depth image corresponding to the 2D color image; and
allocate a color value of the image pixel of the 2D color image to a location of a display pixel corresponding to the view direction of the image pixel of the 2D color image.

17. The apparatus of claim 15, wherein the instructions cause the processor to:
detect a boundary region between a foreground and a background in the 2D color image;
determine a blended color value by blending a color of the foreground and a color of the background in the boundary region; and
allocate the blended color value to a location of a display pixel corresponding to the boundary region.

18. The apparatus of claim 15, wherein the instructions cause the processor to:
determine whether the location of the display pixel to which the color value of the image pixel is in a smoothing region; and
allocate the color value of the image pixel or a smoothed color value obtained by performing smoothing to the location of the display pixel based on a result of the determining.

19. The apparatus of 15, wherein the instructions cause the processor allocate a color value by:
determining the location of the display pixel using a first model associated with a view direction of the display pixel and a second model associated with the view direction of the image pixel.

20. The apparatus of claim 19, wherein the first model is based on a correlation between the location of the display pixel and the view direction of the display pixel, and the second model is obtained by modeling a direction of a light ray to be output from the image pixel based on a location of the image pixel.
